(19) United States
(12) Patent Application Publication
(10) Pub. No.: US 2025/0205921 A1
(43) Pub. Date: Jun. 26, 2025

(54) LUMBER SELECTION END ARM APPARATUS AND METHODS OF USE

(71) Applicant: Sage Automation Inc., Beaumont, TX (US)

(72) Inventor: Timothy W. Stephens, Beaumont, TX (US)

(21) Appl. No.: 18/981,728

(22) Filed: Dec. 16, 2024

Related U.S. Application Data
(60) Provisional application No. 63/613,035, filed on Dec. 20, 2023.

(51) Int. Cl. B27B 31/00; B65G 59/02; B65G 61/00

(52) U.S. Cl. CPC B27B 31/00; B65G 59/02; B65G 61/00; B65G 2201/0282

(57) ABSTRACT

Certain embodiments of the invention are directed to apparatus, system, and methods for workpiece assembly, and in particular, to automated systems and methods for lumber picking and retrieval that use a plurality of pick cups aligned in columns. In certain aspects an end arm apparatus selects lumber from a source stack of lumber picking at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more selected boards from the stack of lumber, and moves the board from the source stack to an assembly station(s).

### RELATED APPLICATIONS

This application is a US Utility application claiming priority to U.S. Provisional Application No. 63/613,035 filed Dec. 20, 2023 which is incorporated herein by reference in its entirety.

### STATEMENT REGARDING FEDERALLY FUNDED RESEARCH

None.

### BACKGROUND

### I. Field of the Disclosure

Embodiments of the invention are generally directed to the field of material handling, in particular embodiments are directed to the field of lumber handling systems, apparatus, and related methods.

### II. Background

One problem with conventional technology is that, when manually loading wood into the infeed systems, the human operator needs to determine how to orient the wood, which increases the cost of labor when manufacturing structures using wood boards (lumber).

U.S. Pat. No. 8,960,244 to Aylsworth et al. titled “AUTOMATED LUMBER RETRIEVAL AND DELIVERY,” issued Feb. 24, 2015. U.S. Pat. No. 8,960,244 describes an automated lumber handling system that laser-scans the top profile of multiple stacks of lumber, each of which contain boards of a unique size. Based on the scanned profiles, the system determines the order in which individual boards from a chosen stack should be transferred to a numerically controlled saw. The saw cuts the boards to proper size, and in the proper sequence to facilitate orderly assembly of a roof truss or prefabricated wall. In some examples, the system lifts individual boards by driving two retractable screws, or some other piercing tool, down into the upward facing surface of the board. A track mounted cantilever, holding the screws and a laser unit, translates over the lumber stacks to retrieve and deliver individual boards and, while doing so, the laser repeatedly scans the stacked lumber profiles on-the-fly to continuously update the profiles. The open cantilever design facilitates replenishing the stacks of lumber.

U.S. Pat. No. 10,239,224 to Aylsworth titled “LUMBER RETRIEVAL METHOD WITH SELECTIVE CROWN ORIENTATION,” issued Mar. 26, 2019. U.S. Pat. No. 10,239,224 describes a lumber handling method that identifies the existence and direction of crowning in dimensional lumber and automatically orients the board and specifies a cutting direction prior to a saw cutting the board into one or more board segments to be used in a structural board assembly, such as in a truss or a wall panel. The picking method uses two individual picking heads, each with its own vertical axis which can be operated independently. The picking heads are mounted to a single trolley and move together in the horizontal direction. The spacing on the two picking heads is wide enough to pick up two wide boards (2″×12″ for example) without interference from each other. Boards can easily be picked up from the same stack of lumber (e.g., from a first stack of lumber) if like sized boards are required or picked up from two different lumber stacks to deliver different sized boards.

U.S. Pat. No. 10,493,636 to Weinschenk titled “AUTOMATED SYSTEM AND METHOD FOR LUMBER PICKING,” issued Dec. 3, 2019. U.S. Pat. No. 10,493,636 describes a system that includes a lumber-pickup arm having a plurality of suction cups in a staggered configuration to pick up a piece of lumber that may be cracked, crooked or askew on the pile of lumber from which it is to be picked. In some embodiments, the system performs a method that includes locating a selected piece of lumber to be picked up; lowering the pickup arm so that at least some of the plurality of suction cups are seated on a first surface of the selected piece of lumber; reducing air pressure within the at least some of the plurality of suction cups; raising and moving the pickup arm to move the piece of lumber to a first destination; and increasing air pressure within the at least some of the plurality of suction cups to release the piece of lumber at the first destination. Cups not holding vacuum are deactivated.

There is a need in the art for better pickers and grabbers for temporarily attaching a piece of lumber to a moving arm in automated systems and methods for lumber selection and sorting for workpiece assembly, such as the assembly of wooden roof trusses, pre-assembled walls, and the like.

### SUMMARY

Embodiments of the present invention relate to devices and methods for workpiece assembly. Specifically, aspects are directed to automated systems and methods for lumber picking and retrieval that use a plurality of pick cup columns (picking columns). In certain aspects an apparatus described herein selects lumber from a source stack of lumber and provide a gantry that picks at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more selected boards from the stack of lumber (e.g., from one or more layers), and moves the selected boards in a direction generally perpendicular to the long axis of the board from the source stack and then on to an assembly station(s). A source stack of lumber is a vertical stack of a plurality of layers of lumber, typically lumber from the top (first layer) or the second layer from the top are selected. A lumber retrieval system is configured to select, engage, and deliver lumber to a secondary process, such as an assembly station. The lumber retrieval system includes an end of arm apparatus having a plurality of independent picking columns, the columns having a plurality of picking cups. Selected picking cups attach to a targeted board and allow for lifting and moving the selected board. The lumber handling apparatus retrieves a selected number of lumber pieces or boards from a source stack with each picking column being independently regulated and selecting at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more lumber pieces. As used herein, lumber or lumber pieces or boards include boards of various dimensions and sources. Certain stacks of lumber can be homogeneous (boards of the same general shape and size) or heterogeneous (boards differing in shape and size). The board length can be but is not limited to 8 feet to 20 feet and a width of 3½ inch to 12 inches and a thickness of ¾ inch to 3½ inches. The boards are positioned in a layer adjacent to other boards of the same layer, each board being substantially parallel and in substantially the same plane to other boards in the layer.

Methods of the invention includes, but is not limited to locating and selecting the lumber piece to be picked up; lowering an end arm so that the pick cups are seated on the piece of lumber (attached); activating selected pick cups; raising and moving the end arm to move the piece of lumber to its destination; and releasing the piece of lumber by releasing the vacuum and/or applying compressed air to release (detach) the pick cups.

In certain embodiments the selection methods for lumber picking can include (i) positioning and lowering a picking apparatus having a plurality of picking columns to contact a source stack of lumber, the stack having one or more layers of lumber pieces; (ii) aligning the picking columns to the targeted lumber pieces, wherein alignment includes horizontal alignment of lumber pieces and vertical alignment of picking columns with respect a top surface of the stack; (iii) activating a predetermined number of picking columns to engage targeted lumber pieces to be picked, wherein activating includes engaging and attaching picking cups of the picking columns; (iv) lifting the targeted lumber pieces from the source stack; (v) moving the targeted lumber pieces to a destination; and (vi) depositing the targeted lumber pieces by disengaging the picking apparatus at a deposit location. In certain aspects there are at least at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more picking columns with each picking column including at least 1, 2, 3, 4, 5, 6, 7, 8, 9, 10 or more picking cups. Depending on the width of the board, one or more picking columns can engage a lumber piece and secure the piece for lifting. During alignment the picking apparatus can engage the edge of the lumber to apply force to align and or collect the lumber pieces to maximize contact through the edges of adjacent lumber pieces. The picking apparatus can include alignment guides that engage an edge or edges of a board and apply a force to push or collect boards to align with the picking apparatus. Boards of 1, 2, 3, or more layers can be engaged with the alignment guides. The picking apparatus is configured to pick from incomplete rows by extending a picking column to the next row in the stack if a row has been partially vacated by an earlier picking round. The picking apparatus can be configured to align a first incomplete layer and a second lower layer for the picking process.

For example, a first pick of a lumber stack of 13 2×4s per layer can be used for an initial pick of 10 2×4s, leaving 3 2×4s in the first layer with 13 2×4s in the second layer (3 of the second layer covered by the 3 remaining 2×4s of the first layer. If 6 2×4s are needed the 3 remaining 2×4s of the first layer will be engaged and 3 2×4s of the second layer will be engaged. The 6 selected 2×4s lifted and delivered leaving a stack with a 10 2×4 top layer. The picking columns have a vertical displacement along with the appropriate sensor(s) and alignment mechanisms to engage either a first and/or a second layer of lumber pieces.

Certain embodiments are directed to a lumber handling apparatus comprising: a support platform having a top, bottom, long edge, and short edge; a vacuum manifold mounted on the top of the support platform, the vacuum manifold comprising a plurality of independently regulated vacuum manifold valves; a plurality of pick cups (104) arranged in thirteen pick cup columns (105), each column having a plurality of pick cups (104), each pick cup column is operably connected to a vacuum manifold valve (103) and each pick cup column is configured to be independently operable, a plurality of mount sensors operably coupled to a pick cup column, the mount sensor configured to regulate the activation of the pick cup column; and a controller operably coupled to the lumber handling apparatus configured to regulate the engagement of each pick cup column. The assembly can include at least two mount sensors. In certain aspects the assembly includes two or more lateral sensors. The platform can be formed by longitudinal beams along the length of the platform and horizontal beams perpendicular to the longitudinal beams forming the support platform. The assembly can include a first and second mounting plate, the first mounting plate being a support plate connected to the platform and the second mounting plate being mounted a distance above the support plate and being connected to the vacuum manifold. The assembly can include one or more vacuum sources operably coupled to the vacuum manifold.

An apparatus described herein can be included in a lumber handing system comprising: a lumber handling apparatus and a gantry support for the lumber handling apparatus, as well as apparatus pathways and control elements.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a chemical composition and/or method that “comprises” a list of elements (e.g., components or features or steps) is not necessarily limited to only those elements (or components or features or steps) but may include other elements (or components or features or steps) not expressly listed or inherent to the chemical composition and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a chemical composition and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1. An illustration of one example of an end effector from a top right perspective.

FIG. 2. An illustration of one example of an end effector from a bottom right perspective.

FIG. 3. An illustration of one example of an end effector from a front perspective.

FIG. 4. An illustration of one example of an end effector from a side perspective.

FIG. 5. An illustration of one example of an end effector from a top perspective.

FIG. 6. An illustration of one example of an end effector from a bottom perspective.

### DESCRIPTION

The following discussion is directed to various embodiments of the invention. The term “invention” is not intended to refer to any particular embodiments or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to imply that the scope of the disclosure, including the claims, is limited to that embodiment.

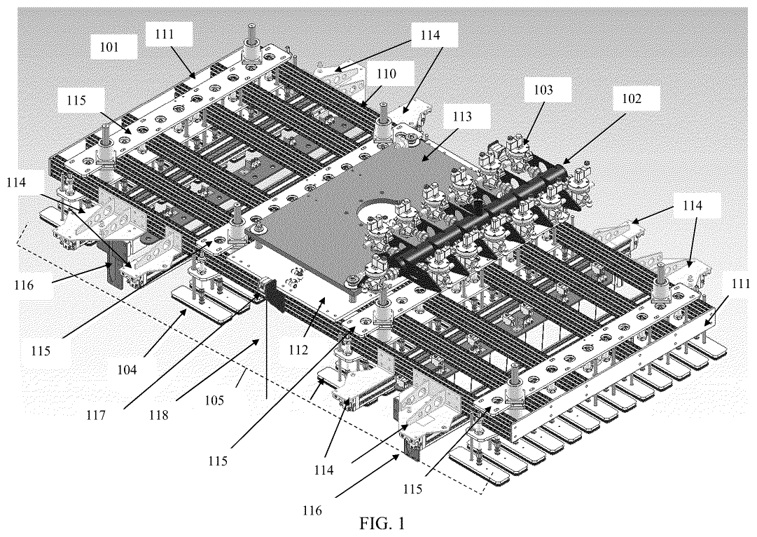

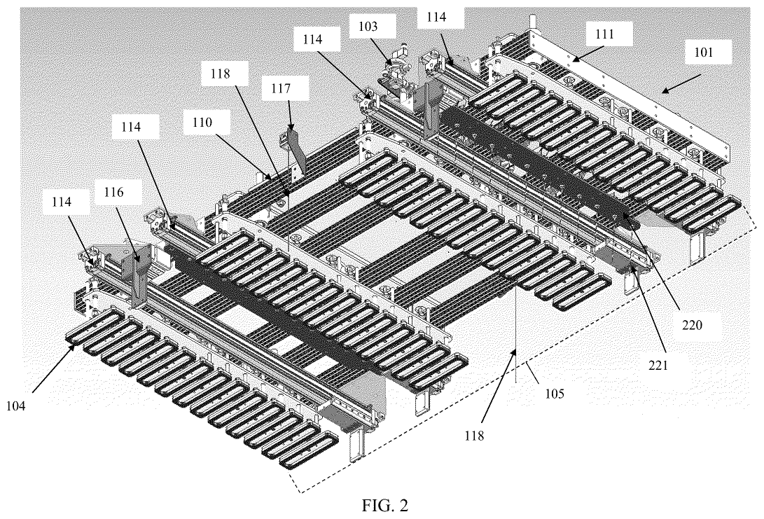

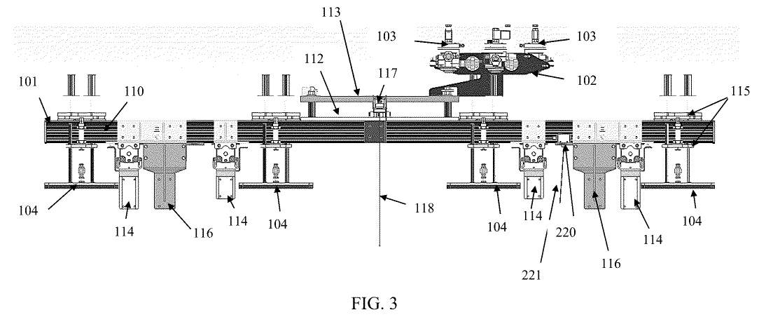

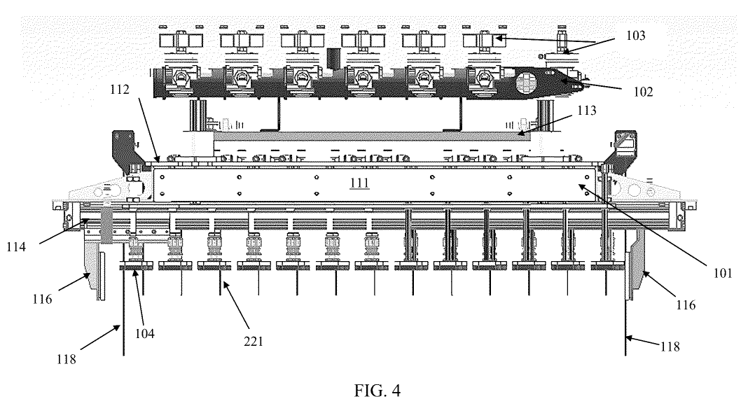

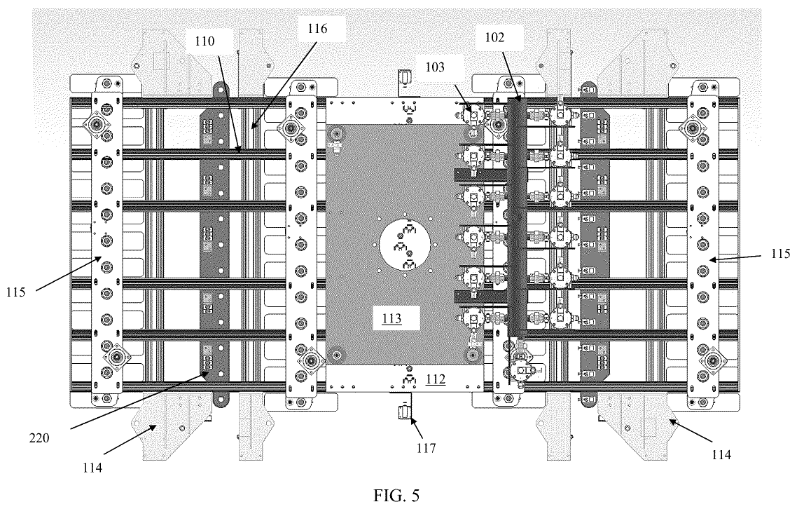

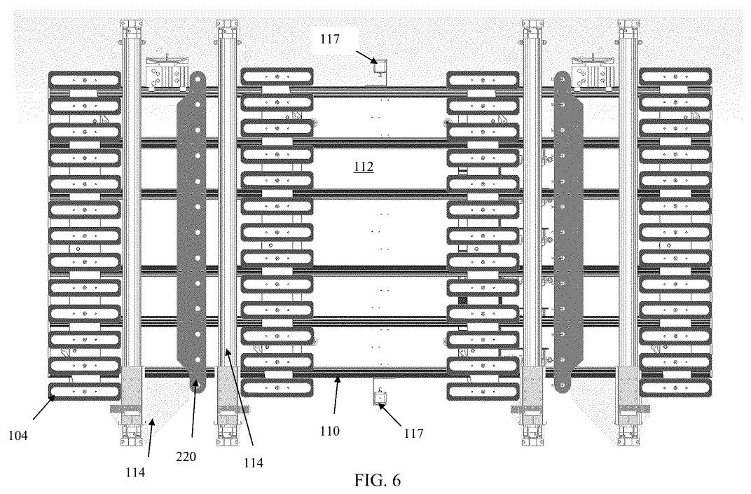

FIG. 1, FIG. 2, FIG. 3, FIG. 4, FIG. 5, and FIG. 6 provide an illustration of various perspectives of one example of an end effector (FIG. 1 a top right perspective, FIG. 2 a bottom right, FIG. 3 a front perspective, FIG. 4 a side perspective, FIG. 5 a top perspective, and FIG. 6 a bottom perspective): The lumber handling apparatus includes support platform 101 having a top, bottom, long edge, and short edge. In certain aspects the platform can be constructed of beams running parallel to the long axis (longitudinal beams 110) with the beams having transverse end cap 111 on both ends of the platform connected to longitudinal beams 110. Pick cup mounts 115 are also positioned transverse to longitudinal beams 110. First mount plate 112 and a second mount plate 113 are connected to support platform 101. First mount plate 112 is connected to the platform via attachment to longitudinal beam 110. Second mount plate 113 is connected to and elevated above first mount plate 112. Various clamp mounts 114 are positioned along the perimeter of support platform 101. Secondary mount clamps 116 project down from the support platform bottom. Vacuum manifold 102 is mounted on the top of the support platform 101. Vacuum manifold 102 includes a plurality of independently regulated vacuum manifold valves 103. Each of the valves are in communication with one pick cup column 105. Each valve is independently regulated, and any combination of pick cup columns can be activated or deactivated at any time or during any process. Pick cups 104 are arranged in pick cup columns 105. Pick cup columns 105 can be arranged such that a plurality of pick cup rows form. Pick cups 104 are spaced along the pick cup column to disperse the lift force across the length of a target lumber piece or board. Each pick cup column 105 is configured to lift and transport one lumber piece or board. Each column can have at least 2, 3, 4, 5, 6, 7, 8, 9, 10 or more pick cups. Pick cup columns 105 are operably connected to vacuum manifold 102 by a vacuum manifold valve 103. Each pick cup column is configured to be independently operated. Mount sensors can be operably coupled to a pick cup 104 within a pick cup column 105 with the mount sensor configured to obtain data on position and distance of a target lumber piece or board, the data is used to regulate the activation/deactivation of pick cup column 105 and/or the position of the support platform relative to the source stack. Lateral sensor 117 emits beam 118 for detection of the surface of product to be picked. A controller can be operably coupled to the various components of lumber handling apparatus to regulate the engagement/disengagement of each pick cup column 105 as well as movement of the end arm apparatus. The assembly is configured to be coupled to one or more vacuum sources or air pressure sources which are operably coupled to the vacuum manifold.

FIG. 2 provides an illustration of one example of an end effector from a bottom right perspective. Support platform 101 constructed of longitudinal beams 110 with the beams having transverse end cap 111 on both ends of the platform connected to longitudinal beams 110. Pick cup mounts 115 (with pick cups 104 connected) are positioned transverse to longitudinal beams 110. Transverse sensors mount 220 are connected to the bottom of support platform and operably coupled to sensor splitters 221 that project from sensor mount 220. Various clamp mounts 114 are positioned along the perimeter of support platform 101. Secondary mount clamps 116 project down from the support platform bottom and traverse the width of support platform 101. Pick cups 104 are arranged in pick cup columns 105. Pick cup columns 105 can be arranged such that a plurality of pick cup rows form. Pick cups 104 are spaced along the pick cup column to disperse the lift force across the length of a target lumber piece or board. Each pick cup column 105 is configured to lift and transport one lumber piece or board. Each column can have at least 2, 3, 4, 5, 6, 7, 8, 9, 10, or more pick cups. Pick cup columns 105 are operably connected to vacuum manifold 102 by a vacuum manifold valve 103. Each pick cup column is configured to be independently operated. Mount sensors can be operably coupled to a pick cup 104 within a pick cup column 105 with the mount sensor configured to obtain data on position and distance of a target lumber piece or board, the data is used to regulate the activation/deactivation of pick cup column 105 and/or the position of the support platform relative to the source stack. A controller can be operably coupled to the various components of lumber handling apparatus to regulate the engagement/disengagement of each pick cup column 105 as well as movement of the end arm apparatus.

The lumber handling apparatus described above can be included in a lumber handling system that includes a controller and a gantry support for the lumber handling apparatus.

The lumber handling apparatus can be used to perform lumber handling methods.

The lumber end arm selection apparatus of the present invention provides a vacuum-activated picker arm that includes a plurality of independently regulated pick cup columns that can be used by an operator to select and move a variable number of lumber pieces at any given time. In certain aspects, a plurality of compressed-air blowers can be included in the end arm apparatus to remove sawdust or other debris that may be on the piece of lumber to reduce the amount of leakage at the pick cups. Some embodiments further include a plurality of compressed-air blowers to speed the release of the selected lumber piece(s) once it reaches its destination.

In some embodiments, an apparatus, system or method includes a computer processor/controller, wherein the computer processor/controller includes: a plurality of input data devices, a plurality of output data devices, and a plurality of sensors, wherein a system can further includes an end of arm/gantry assembly integrated with the computer processor to select and transport a selected number of lumber pieces based on software code executing in the computer processor. Using the present invention, a user can efficiently supply material to an assembly station saving time, money, and increase daily or hourly production.

A system and associated method can operate on a computer processor having a plurality of input data devices, a plurality of output data devices, a plurality of sensors, a database, software code, and a wireless interface, wherein the computer processor is integrated with mechanical components, and wherein the method includes eliciting and receiving into the computer processor data parameters from a first human user; obtaining incoming data points about lumber pieces or source stacks from the plurality of sensors (e.g., in some embodiments, from whisker sensors, optical distance sensors and/or three-dimensional (3D) machine-vision systems); processing the data parameters to obtain processed data parameters; storing the processed data parameters; and, based on the input engage the appropriate lumber pieces of a source stack, lift the selected pieces, and transport the selected pieces to an appropriate assembly station.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

In some embodiments, the sensors of the present invention include a plurality of single-point distance-detecting optical systems or whisker/splitter sensor systems. In some embodiments, the sensors include mechanically driven electrical sensors. In some embodiments, the sensors include monochromatic-camera or color-camera technologies. In some embodiments, the sensors include laser distance detectors. In some embodiments, the sensors include motion detection. In some embodiments, the sensors include weight detection.

A controller system can embody the system data processing and software integration of the system components. The system can accept data from a user and/or from a stored set of data that correlates characteristics of the source stack with certain actions to be taken by the system, based on the end-product to be built using the pieces of lumber. In some embodiments, the controller system elicits and receives, from a human user using an input/output device, selection data that the system uses to select one or more sets of criteria and corresponding actions from a stored database that has been pre-loaded with a plurality of sets of criteria and corresponding actions that have been predetermined to meet requirements for each of a plurality of possible end products to be built using the pieces of lumber. In some embodiments, the system utilizes one or more of the user devices of each user, such as a desktop personal computer, laptop computer, tablet computer, smartphone, and/or position-sensing device(s). In some embodiments, the human user provide input regarding which one of a plurality possible end-products is to be manufactured, wherein the criteria and actions for each respective end product is customized and optimized for that respective end product and stored in database, such that when an indication is received from the device of user, that set of data is then used for the operations of the system. In some embodiments, sensors gather physical data from a stack source. In some embodiments, distance data and layer content is received from each of one or more sensors for each of a plurality of point locations on one or more pieces of lumber. In some embodiments, those distance data are processed to obtain XYZ coordinates for each of the plurality of point locations, and the edges and surfaces of the one or more pieces of lumber is determined.

In some embodiments sensors determine the position and orientation of lumber piece or board. In some embodiments, sensor inputs are used to position and/or activate the appropriate pick cup columns to pick up a lumber piece(s) or board(s). The lumber piece(s) or board(s) are picked up by pick cup columns, carried along a path, and placed at an assembly station.

A lumber selection system described herein can include a gantry that moves in and out relative to a plurality of stacks of lumber.

A pick cup can include a pliant supple rugged suction-cup, vacuum pad, or vacuum foam operably coupled to a compressed-air source or a vacuum source via a valving mechanism. A controller can independently control a plurality of valves to generate a vacuum for a pick cup and/or to release the vacuum or blow away sawdust or other debris. When the pick cup is seated on a piece of lumber and a vacuum force applied the pick cup holds the piece of lumber against the suction cup, which allows the picker to lift and move the piece of lumber. When a controller signals the release of a piece of lumber compressed air is fed into vacuum cup or the vacuum is released. In some embodiments, a sensor is used to detect and/or measure an amount of excess pressure and/or reduced pressure (i.e., vacuum) in the suction cup, and to provide a feedback signal that is received by the controller to adjust its operation of valves.

Methods of the invention includes: locating and selecting the lumber piece to be picked up; lowering an end arm so that the pick cups are seated on the piece of lumber; activating selected pick cups; raising and moving the end arm to move the piece of lumber to its destination; and releasing the piece of lumber by releasing the vacuum and/or applying compressed air to the pick cups.

1. A method for lumber picking comprising:
(i) positioning and lowering all or a portion of a picking apparatus to contact a source stack of lumber, the picking apparatus having a plurality of independently activable picking columns and the source stack of lumber having a plurality of lumber layers with a first layer having at least one lumber piece and all successive layers having at least 4, 5, 6, 7, 8, 9, 10, 11, 12, 13, 14, 15, 16, 17, 18, 19, 20, 21, 22, 23, 24, 25, 26, 27, 28, 29, 30 or more lumber pieces;
(ii) aligning the picking columns to the targeted lumber pieces, wherein alignment includes horizontal alignment of lumber pieces and vertical alignment of picking columns with respect a top surface of the targeted lumber pieces;
(iii) activating a predetermined number of picking columns to engage a selected number of the targeted lumber pieces to be picked and reversibly coupling the targeted lumber pieces to one or more picking columns by engaging and attaching a plurality of picking cups in the picking column;
(iv) lifting the targeted lumber pieces from the source stack;
(v) moving the targeted lumber pieces to a destination; and
(vi) depositing the targeted lumber pieces by disengaging the picking apparatus at a deposit location.

2. The method of claim 1, wherein the picking apparatus has 13 or more picking columns with each picking column having 1 or more picking cups.

3. The method of claim 1, wherein one or more picking columns can engage a single lumber piece that is part of the targeted lumber pieces and secure the lumber piece for lifting.

4. The method of claim 1, wherein during the aligning step the picking apparatus engages the edges of the targeted lumber to apply a horizontal force aligning and collecting the targeted lumber pieces to maximize contact through the edges of adjacent lumber pieces.

5. The method of claim 1, wherein the picking apparatus is configured to pick from incomplete layers by extending a picking column to the next layer in the stack if a row has been partially vacated by an earlier picking round.

6. The method of claim 1, wherein the picking apparatus is configured to align a first incomplete layer and a second lower layer before the picking process.

7. A lumber handling apparatus comprising:
a support platform (101) having a top, bottom, long edge, and short edge;
a vacuum manifold (102) mounted on the top of the support platform (101), the vacuum manifold (102) comprising a plurality of independently regulated vacuum manifold valves (103);
a plurality of pick cups (104) arranged in thirteen pick cup columns (105), each column having a plurality of pick cups (104), each pick cup column is operably connected to a vacuum manifold valve (103) and each pick cup column is configured to be independently operable;
a plurality mount sensor operably coupled to a pick cup column, the mount sensor configured to regulate the activation of the pick cup column; and
a controller operably coupled to the lumber handling apparatus configured to regulate the engagement of each pick cup column.

8. The assembly of claim 7, comprising at least two mount sensors.

9. The assembly of claim 7, further comprising lateral sensors.

10. The assembly of claim 7, wherein the platform comprises longitudinal beams along the length of the platform and horizontal beams perpendicular to the longitudinal beams forming the support platform.

11. The assembly of claim 7, further comprising a first and second mounting plate, the first mounting plate being a support plate connected to the platform and the second mounting plate being mounted a distance above the support plate and being connected to the vacuum manifold.

12. The assembly of claim 7, further comprising a vacuum source operably coupled to the vacuum manifold.

13. A lumber handing system comprising:
a lumber handling apparatus of claim 7, and
a gantry support for the lumber handling apparatus.
